(19) United States
(12) Patent Application Publication
(10) Pub. No.: US 2007/0037614 A1
(43) Pub. Date: Feb. 15, 2007

(54) METHOD AND APPARATUS FOR RFID-TRIGGERED PERSONAL REMINDERS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/551,702

(22) Filed: Oct. 20, 2006

Related U.S. Application Data
(60) Provisional application No. 60/748,832, filed on Dec. 10, 2005.

(51) Int. Cl. H04M 1/00

(52) U.S. Cl. 455/575.1

(57) ABSTRACT

A portable computing device is configured to store personal reminders. Each personal reminder includes reminder content and a trigger establishment associated with the reminder content. An RFID scanner is included as an integral or peripheral component, and the RFID scanner is configured to detect and read data from RFID chips when it comes within local proximity of RFID chips. RFID chips are positioned proximal to real physical establishments and contain establishment data indentifying the physical establishment, type of establishment, or portion of the establishment to which the RFID chip is proximally positioned. When the portable computing device comes within local proximity of the RFID chip, establishment data is received by the portable computing device indicating which establishment the portable computing device is local to. Upon receiving such data, the user is alerted to reminder content relationally associated with that particular establishment, type of establishment, and/or portion of establishment.

### RELATED APPLICATION DATA

This application claims priority to provisional application Ser. No. 60/748,832, filed Dec. 10, 2005, the disclosure of which is hereby incorporated by reference as if fully set forth herein. This application is related to patent application Ser. No. 11/427,325, filed Jun. 28, 2006, the disclosure of which is hereby incorporated by reference as if fully set forth herein.

### FIELD OF THE APPLICATION

The present invention relates generally to a method, system, and apparatus for providing personal reminder notifications to a user in response to detection of a Radio Frequency Identification (“RFID”) tag.

### BACKGROUND

A Radio Frequency Identification (“RFID”) tag typically contains an electronic microchip with a memory portion, permanently attached to a substrate having a planar antenna. Each RFID tag is generally tuned to operate at a specific frequency and includes a unique identifier stored in the memory portion. Unique information, such as a product code and manufacturer code may be sent to the microchip for storage in the memory portion by means of an RF field provided by an external “scanner” device. The scanner also provides a means for remotely reading data stored in the memory portion of the microchip. There are a great many current applications of RFID systems. A common application includes affixing RFID tags to products, packages, luggage, people, and other physical articles that one might wish to identify from a distance using an RFID scanner. For example, U.S. Pat. No. 6,970,088, which is hereby incorporated by reference, is understood to disclose a system for using RFID tags to track the changing location of luggage in an airport environment. This system, like most RFID enabled embodiments, affixes an RFID tag to an article and uses one or more scanners to detect the presence of that article at various locations throughout an airport. Similarly, U.S. Pat. No. 6,956,538, which is hereby incorporated by reference, is understood to disclose a system for using RFID tags to track the location of inventory as it is moved about a warehouse.

While such systems are effective in tracking the location of physical articles as they move about a physical establishment, such systems do not, however, provide a means by which a user may author a digital reminder and automatically receive that reminder based upon that user coming within a certain proximity of an RFID tag identified establishment, type of establishment, or portion of an establishment. Typical RFID systems affix tags to movable objects in the environment and use scanners to detect the motion of movable objects.

### SUMMARY

People use a variety of techniques for reminding themselves of pending tasks that must be completed in their lives. For example, many people write to-do lists to remind themselves of the various things they need to get done, often crossing off items as they are completed. With the advent of handheld personal computing devices, users are now able to keep to-do lists as digital files they store and access on electronic devices they keep with them. Such devices may include PDAs, cell phones, personal media players, and other common portable computing devices. While such paper reminders and electronic reminders are useful, there are some tasks in a user's life that he or she may wish to be reminded of at times when he or she comes within a certain close proximity of a particular establishment, a particular type of establishment, or a particular spatial portion of an establishment in the real physical world. For example, a user may wish to be reminded that he or she needs to pick up laundry from the Dry Cleaners at times when he or she comes within a certain close proximity of the dry cleaners establishment. Similarly, a user may wish to be reminded to buy light bulbs the next time he or she comes within close proximity to a type of establishment that sells light bulbs. Similarly, a user may wish to be reminded to buy milk the next time he or she comes within certain close proximity of the dairy section of one of a plurality of grocery stores. The present invention provides such functionality by enabling users to create “Personal Digital Reminders” and associate such Reminders with particular establishments, types of establishments, and/or spatial portions of establishments within in the real physical world. As defined herein, a Personal Digital Reminder is a digital data store that may include text, audio, images, graphics, and/or video, and describes or indicates one or more pending tasks that the user intends to perform in the future. The present invention also provides such functionality by enabling a portable computing device that is carried on the person of the user to trigger an alert and/or display the Reminder based upon detecting an RFID tag that identifies an establishment, type of establishment, and/or spatial portion of the establishment that is associated with a stored Personal Digital Reminder. Upon detecting an RFID tag that identifies a particular establishment, type of establishment, and/or spatial portion of an establishment, the portable computing device of the present invention alerts the user and/or displays any Personal Digital Reminders that have been authored and stored in memory by the user which have been relationally associated by the user to that particular establishment, type of establishment, and/or spatial portion of establishment.

In some cases the action verb may be implicit in the fact that the Personal Digital Reminder relates to a pending task. For example, the text file may simply include the word “milk” because it is understood by the user who authored the Reminder that the task required is to buy milk. A key is to include enough information such that the user who authored the Reminder is reminded of the pending task that he or she is thinking of. In some embodiments the Personal Digital Reminder may be a voice message left by recording and storing a digital audio file. For example, the user may record a digital audio file of himself or herself saying “buy dog food” or “buy milk” and thereby create a Personal Digital Reminder that includes audio voice content. The Personal Digital Reminder may also include video of the user. For example, the user may record a video file of himself or herself saying “buy dog food” and thereby create a Personal Digital Reminder that includes video content.

In addition to including text, audio, images, graphics, and/or video that indicates one or more pending tasks that the user intends to perform in the future, the Personal Digital Reminder as defined herein also includes a relational association to one or more physical establishments, types of physical establishments, and/or spatial portions of physical establishments in the real physical world. Such an indication of a real physical establishment, type of physical establishment, and/or spatial portion of a physical establishment in the real physical world that a Personal Digital Reminder is associated with is referred to herein as the “Associated Trigger Establishment.”

For the sake of brevity, the phase Personal Digital Reminder is sometimes referred to herein simply as the “Reminder.” Similarly, the phrase Associated Trigger Establishment will often be referred to herein as the “Trigger Establishment” or simply the “Establishment.” Also, as used herein the pending future tasks that are authored by the user and stored as text, audio, images, and/or video files within a Personal Digital Reminder will be referred to herein simply as the “Task Content” of the Personal Digital Reminder. Thus a Personal Digital Reminder is a store of Task Content that is relationally associated with a Trigger establishment in the real physical world. The Personal Digital Reminder may also include parameters such as flags and variables that describe how and when the Reminder should be triggered as well as the current status of the Reminder. Specific examples of such flags and variables are discussed below. In general, the set of Personal Digital Reminders that have been authored by the user and relationally associated with one or more Trigger Establishments is stored in a database referred to herein as the Reminder Database. The Reminder Database is accessible by a portable computing device local to the user. In some embodiments of the present invention, a system is provided that includes a portable computing device that has access to the Reminder Database and runs software that will automatically alert the user to appropriate Reminders based upon the detection of an RFID tags that identify an establishment, type of establishment, and/or spatial portion of an establishment that is relationally associated to those Reminders within the Reminder Database.

A system according to the present invention is generally embodied as a portable computing device that is carried on the person of a user. The personal computing device stores one or more Personal Digital Reminders within a memory of the portable computing device. In some embodiments the Reminders may be accessed by the portable computing device from a remote server over a wireless communication link. The portable computing device also includes an RFID Scanner that receives data as a radio signal from one or more RFID tags within a certain proximity of the scanner. The data received provides information indicative of an establishment, type of establishment, and/or spatial portion of an establishment that is physically local to that certain proximity. The RFID scanner may take a variety of forms, although the most common embodiments of the invention includes a radio antenna operative to detect data from one or more RFID tags within a certain proximity range. The RFID tags may be active (including their own power source) or passive (drawing power from the radio signal of the scanner). In some preferred embodiments of the present invention the RFID tags are active because active tags have a longer range and are operative with low-power scanners. Since the scanners according to the present invention are integrated into a portable computing device that generally has limited battery life, low power embodiments are beneficial. Thus active tags are generally desirable for embodiments of the present invention.

A plurality of RFID tags is also included in embodiments of the invention. The plurality of tags may be affixed to physical locations that are proximal to real-world physical establishments. The RFID tags include data indicative of the specific establishment, the type of establishment, and/or the spatial portion of the establishment to which it is proximally affixed. For example, an RFID tag according to the present invention may be affixed to a location upon or near the entry of an establishment. Alternately, an RFID according to the present invention may be affixed to a location proximal to a particular spatial portion of an establishments that sells certain types of goods or provides certain types of services. Such tags are encoded with information that is relationally associated with the establishment and/or type of establishment, and/or spatial portion of the establishment to which it is proximally affixed. For example, an RFID tag including data indicating a Wal-Mart establishment may be affixed to a location near the entry of the establishment. This tag may also include information about which Wal-Mart of a plurality of Wal-Marts is the establishment. This tag may also include information indicating that the tag is located at the entrance to the Wal-Mart. Similarly, an alternate RFID tag may be affixed to a location proximal to the sporting goods section of the Wal-Mart establishment. This tag may include data indicating that it is a Wal-Mart establishment. This tag may also include information indicating that the tag is located proximal to the Sporting Goods Section of the Wal-Mart. In this way a single tag may indicate all three of the type of establishment (e.g., Wal-Mart), the particular establishment (e.g., which Wal-Mart), and the spatial portion of the establishment for which it is associated (e.g., the Sporting Goods section). The data stored within an RFID tag that indicates the particular establishment, type of establishment, and/or spatial portion of the establishment to which the RFID tag is proximal, is referred to herein as the “Tag Establishment Data.”

In many common embodiments of the present invention, a Personal Digital Reminder is triggered (e.g., the user is alerted to the Reminder and/or the Reminder is displayed to the user) based upon a detected signal from an RFID tag located proximal to a physical establishment, where the detected signal is received by an RFID scanner connected to and/or integrated within a portable computer device being used by the user. The detected signal generally includes establishment data, and the establishment data is correlated with one or more Trigger Establishments that have been relationally associated with the Personal Digital Reminder that is triggered. Thus, embodiments of the present invention include a portable computing device that has a RFID scanner proximal to it and access to a Reminder Database that includes one or more Personal Digital Reminders relationally associated with one or more Trigger Establishments. The present invention provides enhanced methods and apparatus is for storing and accessing Personal Reminders and for triggering such Reminders based upon Tag Establishment Data received over a radio link between a portable computing device proximal to the user and a radio data source (e.g., an RFID tag) proximal to an establishment. More specifically, the present invention provides methods and apparatus by which a user may create a Personal Reminder, relationally associate that Personal Reminder to a particular establishment, type of establishment, and/or spatial portion of an establishment within the real physical world (i.e., relationally associate the Reminder to a Trigger Establishment), and configure the Reminder to automatically trigger upon the portable computing device based upon Tag Establishment Data received over a radio link, where the Tag Establishment Data is correlated with a Trigger Establishment. Embodiments of the present invention also include software routines to automatically trigger the Personal Reminder based upon the defined parameters such that the Reminder is displayed to the user when the user comes within certain proximity of a particular establishment, type of establishment, and/or spatial portion of an establishment. In some such embodiments the portable computing device includes software methods to ensure that a Reminder is only displayed to a user once upon coming within such a proximity.

In addition, embodiments of the present invention provide methods and apparatuses by which a user, upon viewing a triggered Personal Reminder, is provided with a user interface option of terminating the Reminder such that it will be deactivated and/or removed from the Reminder Database.

Embodiments of the present invention also provide methods and apparatuses by which a user, upon viewing a triggered Personal Reminder, is provided with a user interface option of deferring the Reminder such that it will not trigger again for some amount of time. In some embodiments the amount of time is a default amount of time. In some embodiments the amount of time is set by the user. In some embodiments the Reminder only triggers if the user remains within radio tag proximity Trigger Establishment for the duration of the defer time.

Embodiments of the present invention further provide methods and apparatuses by which a user, upon viewing a triggered Personal Reminder, is provided with a user interface option of editing the Reminder such that content items may be added, removed, and/or changed by the user.

In addition, embodiments of the present invention provide methods and apparatuses by which a user, upon viewing a triggered Personal Reminder, is provided with a user interface option of requesting a last chance with respect to the Reminder such that it will automatically be triggered again as the user leaves the establishment (generally determined by the user again detecting an RFID tag associated with an entrance to the establishment) and thereby give him or her a last chance to act on the Reminder. In this way the user can view a Reminder upon entering an establishment, remove it from his or her screen, but be assured that upon leaving the establishment he will be reminded again to ensure he did not forget to take the desired action.

Embodiments of the present invention provide methods and apparatuses by which a user, upon viewing a triggered Personal Reminder, is provided with a user interface option of requesting a last chance with respect to the Reminder such that it will automatically trigger again as the user leaves a particular spatial portion of establishment (generally determined by the loss of a detected RFID tag signal associated with the particular spatial portion of the establishment) and thereby give him or her a last chance to act on the Reminder before leaving that spatial portion. In this way the user can view a Reminder associated with a particular spatial portion of an establishment, remove it from his or her screen, but be assured that upon leaving that spatial portion of the establishment, he will be reminded again to ensure he did not forget to take the desired action.

In addition, the methods and apparatus of embodiment of the present invention enable a user to author a Reminder that is relationally associated with a particular establishment, type of establishment, or spatial portion of an establishment, by selecting that establishment and/or that type of establishment and/or that spatial portion of the establishment from a user interface upon authoring the Reminder. In some such embodiments, selection process is performed by a user choosing an establishment, type of establishment, and/or spatial portion of an establishment from a graphical menu of a plurality of establishment choices.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a portable computing device enabled to detect and read data from RFID tags within proximity of the portable computing device according to at least one embodiment of the invention;

FIG. 2 illustrates a system configuration according to at least one embodiment of the invention;

FIG. 3 illustrates a computing device configured with appropriate hardware and software to display a to-do list according to at least one embodiment of the invention;

FIG. 4 illustrates a generalized block diagram of a portable computing device according to at least one embodiment of the invention;

FIG. 5 illustrates user interface options provided to a user upon the triggering and display of a Personal Digital Reminder according to at least one embodiment of the invention;

FIG. 6 illustrates is an example software flow diagram according to at least one embodiment of the present invention; and

FIG. 7 illustrates the entry to an establishment shown as an overhead layout view according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The present invention relates generally to the field of Radio Frequency Identification (“RFID”) tags and associated RFID readers. Embodiments of the present invention invert the typical configuration of an RFID system. Whereas typical RFID systems affix tags to movable objects in the environment and use scanners to detect the motion of movable objects, embodiments of the present invention employ the opposite configuration whereby RFID tags are affixed to one or more locations within a plurality of stationary physical establishments and a portable RFID scanner is incorporated in a portable computing device that is kept proximal to the mobile user. The portable computing device, when coming within a certain proximity of one such stationary establishment-associated RFID tag, detects the presence of the tag through the integrated scanner and thereby identifies that the user is proximal to a particular establishment, the type of establishment, and/or a particular spatial portion of the establishment.

Using this configuration along with software, methods, and apparatuses, embodiments of the present invention enable a user to author a Personal Digital Reminder that automatically triggers an alert and/or is automatically displayed when the user comes within close physical proximity of a particular establishment, type of establishment, and/or portion of an establishment in the real physical world. The Reminder, upon display may be optionally terminated, deferred, edited, and/or set to trigger again upon exiting the Trigger Establishment, by the user using a unique user interface of the present invention. The present invention also provides unique methods and apparatuses that enable a user to author a Personal Digital Reminder that automatically triggers when the user physically exits a particular establishment, type of establishment, and/or spatial portion of the establishment in the real physical world that the user has relationally associated with the Reminder. The present invention also provides methods and apparatus that enable a user to relationally associate a Reminder to a particular establishment and/or type of establishment. For example, a user may relationally associate a particular Personal Reminder to his or her place of work, gym, favorite grocery store, or to all grocery stores. The present invention also provides methods and apparatus by which a user may select a particular type of product and automatically relationally associate a Reminder to all establishments that sell that type of product.

People use a variety of techniques to remind themselves of pending tasks that must be completed in their lives. For example, many people write to-do lists to remind themselves of the various things they need to get done, often crossing off items as they are completed. With the advent of handheld personal computing devices, users are now able to keep to-do lists as digital files they store and access on electronic devices they keep with them. Such devices may include PDAs, cell phones, personal media players, and other common portable computing devices. While such paper reminders and electronic reminders are useful, there are some tasks in a user's life that he or she may wish to be reminded of at times when he or she approaches or enters a particular establishment, a particular type of establishment, and/or spatial portion of an establishment. For example, a user may wish to be reminded that he or she needs to pick up laundry from the Dry Cleaners at times when he or she comes within a certain proximity of the dry cleaners establishment. Similarly a user may wish to be reminded to buy light bulbs the next time he or she enters a store that sells light bulbs. Similarly the user may wish to be reminded to buy milk when he or she enters or nears the dairy section of a particular establishment. Embodiments of present invention provide such functionality by enabling users to create Personal Digital Reminders and associate such Reminders with particular establishment, types of establishments, and/or spatial portions of establishments by relationally associating the Personal Digital Reminders with data indicating a particular establishment, types of establishments, and/or spatial portions of establishments. The data that indicates a particular establishment, types of establishments, and/or spatial portions of establishments in the real physical world are referred to herein as an Associated Trigger Establishment or simply a Trigger Establishment.

Embodiments of the present invention provide such Personal Digital Reminder functionality by enabling a portable computing device that is carried on the person of the user to trigger an alert and/or display the content of a Reminder based upon the detection of an RFID tag within close proximity of the portable computing device, the RFID tag including data that associates the tag with an establishment, type of establishment, and/or spatial portion of an establishment that has been relationally associated with the triggered Reminder. Such data within an RFID tag that associates the tag with an establishment, type of establishment, and/or spatial portion of an establishment that the tag is proximal to is referred to herein as Tag Establishment Data. Thus embodiments of the present invention employ a portable computing device equipped with an RFID scanner that can detect the presence of proximal RFID tags and receive Tag Establishment Data from those tags that contain such data. The portable computing device also includes a store of one or more Personal Digital Reminders, and the content of such Reminders is relationally associated with Trigger Establishments. Embodiments of the present invention are operative to alert the user and/or display the content of a Reminder based upon the receipt of Tag Establishment Data that is correlated with (i.e., at least partially matches) at least one Trigger Establishment that is relationally associated with the triggered Reminder. As referred to herein, “close proximity” refers to a distance such that a user is near enough to the entrance of a physical establishment and/or a particular spatial portion of an establishment that triggering an associated Reminder makes logical sense. In some embodiments close enough may be on the order of 12 ft.

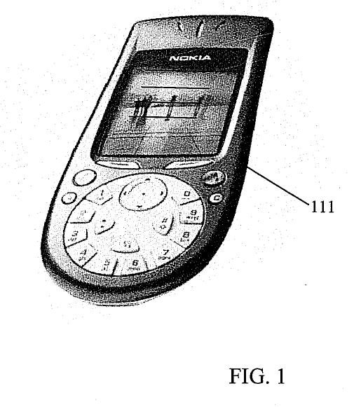

A primary component of embodiments of the present invention is a portable computing device. FIG. 1 illustrates a portable computing device 111 enabled to detect and read data from RFID tags within proximity of the portable computing device 111 according to at least one embodiment of the invention. The term “portable computing device” should be broadly construed as including any mobile computing device that may be carried about or otherwise moved about by the user as he or she traverses a real physical space, including but not limited to a cell phone, a personal digital assistant (PDA), a portable gaming system, a portable media player, a laptop computer, a wristwatch with a computer processor, a wearable computer, or the like. A typical portable computing device 111 has a wireless communication connection to a network such as the Internet although such a connection is not required for all embodiments of the present invention. The portable computing device 111 generally includes a memory for storing one or more Personal Digital Reminders. These Reminders are generally stored within a Reminder Database that may be accessed from a remote server or stored entirely within the memory of the portable computing device 111. The portable computing device 111 generally includes a display for presenting Personal Digital Reminders to users at appropriate moments, the displayed including visual, audio, and/or tactile presentation capabilities. The portable computing device 111 may also include hardware and/or software for presenting alerts to the user, the alerts being used to gain the user's attention when a Personal Digital Reminder is triggered. The alerts produced by the present invention may be visual, aural, and/or tactile in nature. The portable computing device 111 generally includes a RFID scanner that provides data received over a wireless link when the scanner comes within proximity of an RFID data source. The RFID data source is generally a RFID tag that may be active or passive in nature, the data being transmitted from memory of the tag over a radio link to the RFID scanner, the data including Tag Establishment Data as described herein. The RFID scanner generally receives Tag Establishment Data and thereby determines whether the portable computing device 111 has come within close proximity to a particular establishment, type of establishment, and/or spatial portion of an establishment.

The portable computing device 111 also includes software running upon a processor of portable computing device 111, and the software is operative to manage the Personal Digital Reminders and trigger appropriate Reminders based upon the receipt of Tag Establishment Data received as the user moves about the physical world. The portable computing device 111 also includes user interface hardware and software for enabling a user to create, edit, and manage Personal Digital Reminders as well as for enabling a user to associate Reminder content with particular Trigger Establishments. The portable computing device 111 shown in FIG. 1 includes within it a number of components including a local processor, a local memory, a RFID scanner, a display, a user interface, hardware and software for generating alerts, and software for managing and triggering Reminders based upon the detection of Tag Establishment Data as the user moves the portable computing device about the real physical world.

As previously defined herein, a Personal Digital Reminder is a store of digital data that may include text, audio, images, graphics, and/or video, and describes or indicates one or more pending tasks that the user intends to perform in the future. For example, the Personal Digital Reminder may be a text file that includes simple phrases such as “pick up laundry” or “buy milk” or “get gas” or “get cash” or “buy flowers.” In some cases the action verb may be implicit in the fact that the Personal Digital Reminder relates to a pending task. For example, the text file may simply include the word “milk” because it is understood by the user who authored the Reminder that the task required is to buy milk. The key is to include enough information such that a user who authors the Reminder is reminded of the pending task that he or she needs to get done. In some embodiments the Personal Digital Reminder may be a voice message left by recording and storing a digital audio file. For example, the user may record a digital audio file of himself or herself saying “get dog food” or “buy milk” and thereby create a Personal Digital Reminder that includes audio voice content. The Personal Digital Reminder may also include video of the user. For example, the user may record a video file of himself or herself saying “buy milk” and thereby create a Personal Digital Reminder that includes video content.

The digital data files of each Personal Digital Reminder are stored in memory of the portable computing device 111. They may be entered directly into the portable computing device 111 by the user by manipulating the interface of the portable computing device 111. They may be entered into another computer, such as a personal computer, and downloaded into the portable computing device 111 over a wired or wireless link or they may be downloaded from a remote server over a wired or wireless link. In some embodiments the user keeps a database of his or her Personal Digital Reminders on a remote server and downloads them into his or her portable computing device over a wireless link when that portable computing device is active. In this way the user may use a plurality of portable computing devices and always access his Personal Digital Reminders from the remote server, regardless of which device he is using. Basic embodiments of the present invention do not require a remote server. In such embodiments Personal Digital Reminder information may all be stored locally within the memory of the portable computing device. This data includes the content described above, including any text, graphics, audio, and/or video files associated with each Personal Digital Reminder.

In addition to including text, audio, images, graphics, and/or video that indicates one or more pending tasks that the user intends to perform in the future, the Personal Digital Reminder as defined by embodiments of the present invention also stores in memory a relational association to one or more physical establishments, types of establishments, and/or spatial portions of establishments within the real physical world such that the Reminder will be triggered (i.e., an alert will be issued to user and the Reminder will be displayed) when it is determined that the user has come within close proximity of such an establishment, type of establishment, or spatial portion of an establishment. The establishments, types of establishments, and/or spatial portions of the establishments may be defined in memory in a variety of ways—for example, an establishment code may be relationally associated with each type of establishment and particular instantiation of an establishment that uniquely identifies the type and instantiation. Similarly, a spatial portion code may be relationally associated with a particular spatial portion of establishments. For example, a unique code R12434 may indicate that the type of establishment is Wal-Mart, a unique code P1252 may indicate that of all the establishments of the type Wal-Mart, this one is the particular outlet in Arroyo Grande, Calif. A unique code S178 may indicate that a particular spatial portion of the establishment is the Sporting Goods Section. In some embodiments all two or three of the above pieces of information are combined into a single code. In such coded embodiments a master code list generally exists that relationally associates a plurality of different establishments within their respective codes. The master code list may be stored locally within memory of the portable computing device or upon a remote server accessed by the portable computing device.

For the sake of brevity, the pending future tasks that are authored by the user and stored as text, audio, images, and/or video files within a Personal Digital Reminder are referred to herein simply as the “Task Content” of the Personal Digital Reminder. Thus a Personal Digital Reminder is a store of Task Content that is relationally associated with a Trigger Establishment in the real physical world. The Personal Digital Reminder also includes parameters that describe how the Reminder should be triggered. For example, the parameters describe if the Reminder should be triggered upon the user physically entering the Trigger Establishment, exiting the Trigger Establishment, or both entering and exiting the Trigger Establishment. These parameters may be represented in many ways. One common method is to include two flag variables within the data store of the Personal Digital Reminder, the flag variables including an Entry_Trigger_Flag and an Exit_Trigger_Flag. Each flag may be represented by a binary variable and thereby store the value 0 or 1. If the Entry_Trigger_Flag is set to 1, then the Reminder will trigger upon the user physically detecting the Trigger Establishment. If the Entry_Trigger_Flag is set to 0 it will not. If the Exit_Trigger_Flag is set to 1, then the Reminder will trigger upon the loss of a detected Trigger Establishment or upon the detection of a particular data signal that indicates the user has exited the Trigger Establishment. If the Exit_Trigger_Flag is set to 0 it will not. Thus based upon how these two variables are set, the Personal Digital Reminder may be set to trigger upon entering, exiting, or both entering and exiting the Trigger Establishment.

As discussed above, a user interface is provided upon the portable computing device 111 (or other computer on which the Reminder is authored) that enables the user to select the trigger status of the Reminder. The user, for example, may select options from a displayed menu upon the portable computing device. Based upon the options selected, the software of the present invention automatically sets the appropriate Entry_Trigger_Flag and Exit_Trigger_Flag values for that Reminder stored in memory. For example, if a user authoring a particular Reminder selected an item from a menu (or other common user interface metaphor) that indicates the Reminder should trigger both upon the user entering and exiting the defined Trigger Establishment, the software will automatically set the Entry_Trigger_Flag to 1 and the Exit_Trigger_Flag to 1 in the store of data that represents the Reminder.

A Personal Digital Reminder is thus a store data that includes Task Content, one or more Associated Trigger Establishments, and a set of parameters that described how the Reminder will be triggered. Additional parameters may also be included that described the status of the Reminder. For example, in many embodiments an Entry_Status_Flag is stored, the entry status flag indicating if the user is currently inside a Trigger Establishment that has been relationally associated with a particular Personal Digital Reminder. For example, the system is often configured such that the Entry_Status_Flag is set to 1 when the user is physically present within a Trigger Establishment associated with the Reminder, and set to 0 when the user is not physically present within a Trigger Establishment associated with the Reminder.

In addition, a Defer_Time may be stored and associated with each Reminder, the defer time indicating the amount of time that must elapse before a deferred digital Reminder may be triggered again. This process is described below. In a common embodiment the Defer_Time is an integer variable that stores the number of seconds in the assigned Defer_Time. The Defer_Time may be set by the user using a user interface feature of the present invention. A default Defer_Time may also be used if not specifically set by the user. And because not all Reminders will have the Defer feature enabled, the parameters may include a flag that indicates if a particular Reminder has been enabled with the Defer feature. For example a Defer_Status_Flag may be defined as a binary variable that indicates that the Reminder has been deferred by the user. If the flag is set to 1, it indicates the feature has been enabled. If the flag is set to 0 it indicates that the Reminder has not been deferred by the user.

Thus a Personal Digital Reminder is a store of data that includes, Task Content that embodies the information that the user will be reminded of, one or more Associated Trigger Establishments that is relationally associated with the Reminder content, and a set of parameters that described how the Reminder will be triggered as Tag Establishment Data is detected (or ceases to be detected) and additional parameters that indicate certain status information about each Reminder. The Personal Digital Reminder that is authored by the user may be stored in a variety of data structures. In general, the structure that stores the set of currently defined Personal Digital Reminders along with their associated Trigger Establishments and parameters is referred to herein as the Reminder Database. One example data structure for the Reminder Database is partially described below. This particular embodiment only allows for Trigger Establishments that may be particular establishments, types of establishments, and/or spatial portions of establishments. The data structure is represented symbolically as follows:

Reminder[ID].Content_Pointer

Reminder[ID].Establishment_Type[i]

Reminder[ID].Establishment_Unit[i]

Reminder[ID].Spatial_Portion[i]

Reminder[ID].Entry_Trigger_Flag

Reminder[ID].Exit_Trigger_Flag

Reminder[ID].Entry_Status_Flag

Reminder[ID].Defer_Status_Flag

Reminder[ID].Defer_Time

Reminder[ID].Last_Chance_flag

The example data structure above supports some number n of different Personal Digital Reminders wherein ID is a unique identification index number between 1 and n for each Reminder. Thus, if a user created 10 different Reminders and stored them in memory, each can be accessed based upon the index number. Reminder[5] for example, refers to the data for the fifth Reminder in the stored array. Reminder [3] refers to the third Reminder in the stored array. In the general case, the Reminder of identification number ID can be accessed by referring to Reminder[ID].

Using this data structure, each Reminder may be relationally associated to particular task content using a relational pointer. For example, the pointer for the Reminder with ID=5 is stored in Reminder[5].Content_Pointer. This pointer, may for example, point at the memory location of a stored digital file that contains the text, audio, image, and/or video content of the Reminder of ID=5.

In addition to linked content, each Reminder may have a plurality of Associated Trigger Establishments associated with it from 1 to i. In this particular embodiment, each of these Trigger establishments may be a particular establishment, type of establishment, and/or spatial portion of an establishment. Some of these values may be set to NULL if not used for a particular Reminder. Thus for example, a Reminder of ID=3 may have two Trigger Establishments relationally associated with it. These Trigger Establishments might be defined in memory as follows:

Reminder[3].Establishment_Type[1]=Wal-Mart

Reminder[3].Establishment_Unit[1]=Arroyo Grande, Calif.

Reminder[3].Spatial_Portion[1]=Entrance

Reminder[3].Establishment_Type[1]=Target

Reminder[3].Establishment_Unit[1]=Santa Maria, Calif.

Reminder[3].Spatial_Portion[1]=Entrance

The above definition is shown using names and locations to identify the establishment, types of establishments, and/or spatial portion of the establishment. For example the word Wal-Mart is used to indicate that the type of establishment is a Wal-Mart store and the words Arroyo Grande, Calif. is used to indicate which branch of Wal-Mart is the particular establishment and the word Entrance is used to indicate that the spatial location is the entrance of the store. In the more common embodiment, codes are used, as described previously to indicate some or all of these values. For example, coded representations of the same information may be stored in coded form as follows:

Reminder[3].Establishment_Type[1]=R12434

Reminder[3].Etablishment_Unit[1]=P1252

Reminder[3].Spatial_Portion[1]=S178

In some instances the user may wish to have the Reminder trigger upon detecting the entrance tag at any Wal-Mart establishment and may not wish to identify a particular branch. This can be represented in memory, for example, by using a NULL value for the establishment unit. Such a data configuration might be represented as follows:

Reminder[3].Establishment_Type[1]=R12434

Reminder[3].Establishment_Unit[1]=NULL

Reminder[3].Spatial_Portion[1]=S178

In addition to the above Trigger Establishment information, each Reminder has flags associated with it that indicates if the Reminder should trigger upon a user entering an associated Trigger Establishment, upon exiting an associated Trigger Establishment, or both. These are represented by Reminder[ID].Entry_Trigger_Flag and Reminder[ID].Exit_Trigger_Flag which are both binary values as described above. If, for example, Reminder ID=4 is defined such that it will trigger the Reminder when a user enters its associated Trigger Establishment but not trigger the Reminder when the user exits its associated Trigger Establishment the data structure would be defined as follows:

Reminder[ID].Entry_Trigger_Flag=1

Reminder[ID].Exit_Trigger_Flag=0

The other parameters in the data structure above are defined similarly with respect to their respective variable names. For example Reminder[ID].Entry_Status_Flag stores a binary value indicating if the user is currently within a Trigger Establishment associated with that Reminder. Reminder[ID].Defer_Status_Flag stores a binary value indicating if the user has recently deferred that Reminder for some amount of time. Reminder[ID].Defer_Time stores that amount of time (in seconds) if the Reminder has been deferred by the user. Reminder[ID].Last_Chance_Flag is a binary value indicating whether the user has requested a last chance trigger for that Reminder.

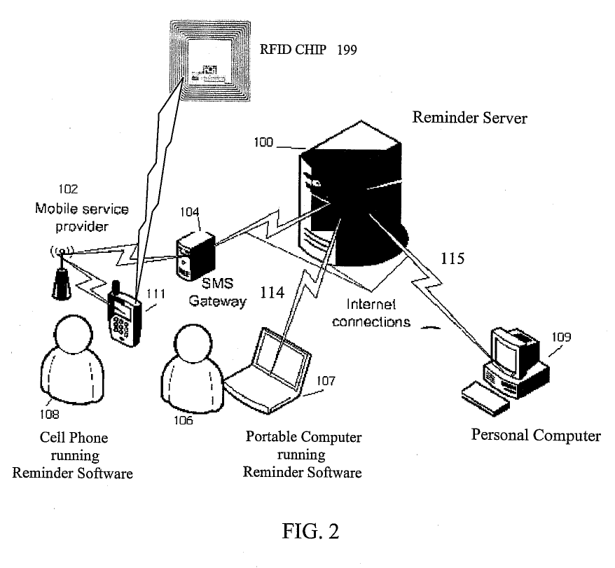

FIG. 2 illustrates a system configuration according to at least one embodiment of the invention. At the heart of the system is the portable computing device 111 that is kept with the user 108 as he or she moves about the real physical world. The portable computing device has a RFID scanner within it (or connected to it) such that it can detect and read Establishment Data from RFID chips 199 within close proximity. In some embodiments of the present invention, the portable computing device 111 includes a wireless transmitter and receiver for communication with an external server 100. In such embodiments, the external server may support certain functionality by storing Personal Digital Reminders that may be downloaded by the portable computing device and then stored locally and/or by storing other information that helps the user correlate Reminders to particular establishments within the real physical world. In embodiments wherein the server 100 stores information that supports and/or enhances the Reminder functionality of the present invention, the server 100 is referred to as a Reminder Server. The Reminder Database that is used by the portable computing device 111 is generally stored local to the portable computing device 111 during use and employs the optional remote server for occasional updates of Reminder information.

Thus with respect to FIG. 2, the present invention provides a computer moderated system that enables a portable computing device to provide alerts to a user when he or she comes within proximity of a particular establishment, type of establishment, and/or spatial portion of establishment that is relationally associated with the Personal Digital Reminder. The alert is provided to user 106 as an audible stimulus imparted through audio display hardware, and/or as a tactile stimulus imparted through tactile display hardware, and/or as a visual stimulus imparted through visual display hardware. The primary function of the alert is to gain the users attention such that he or she knows that a Reminder has been triggered. Once the alert is imparted the user may look upon the screen and/or perform some other action to review the content of the Reminder itself. Upon viewing the contents of the Reminder, the user is automatically provided with user interface options by which the Reminder may be Terminated, Deferred, Reset, Last Chanced, and/or Edited. The software that runs upon the portable computing device, accesses the local Reminder Database, accesses data retrieved from the RFID scanner, determines if alerts should be triggered, and provides the aforementioned user interface options to the user, is referred to herein as Reminder Software and it runs upon one or more processors local to the portable computing device. The Reminder Software is also operative to allow a user to create (author) new Reminders and associate those Reminders with user selected establishments, types of establishments, and/or spatial portions of establishments in the real physical world. In some embodiments the software enables the user to indicate if the authored Reminder should trigger upon entering the establishment, exiting the establishment, or both entering and exiting the establishment.

To perform the Reminder triggering functions described herein, the portable computing device contains within it and/or is connected to one or more RFID scanners. The Reminder Software is operative to access data from the one or more RFID scanners to detect and read Tag Establishment Data at frequent points in time. In general the Reminder Software accesses the RFID scanner data at a rapid and regular interval such that it has access to substantially current information about whether or not the user is within scanner proximity of an RFID tag that contains Tag Establishment Data and thereby determine at regular intervals if the user has come within proximity (or left the proximity) of a particular establishment, type of establishment, or spatial portion of an establishment.

As also shown in FIG. 2, the portable computing devices enabled by the current invention may include a communication link, generally a wireless communication link, to a network such as the Internet and/or cellular network that enable the portable computing device to exchange data with the Reminder server. Embodiments of the present invention may be implemented as a managed service (e.g., in an ASP model) using a Reminder Server 100, which is connected or connectable to one or more networks. The Reminder Server 100 is illustrated as a single machine, but one of ordinary skill will appreciate that this is not a limitation of the invention. More generally, the service may be provided by an operator using a set of one or more computing-related entities (systems, machines, processes, programs, libraries, functions, or the like). In a typical implementation, the service comprises a set of one or more computers. A representative machine is a network-based server running commodity (e.g., Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-accessible Internet, a corporate intranet, a private network, or any combination thereof, depending on the desired implementation environment. As illustrated FIG. 2, the Reminder Server 100 is also in communication with a mobile service provider (MSP) 102 through a gateway, such as SMS gateway 104.

As also illustrated in FIG. 2, one or more users 106 may register for the service, typically by using the portable computing device 111 or some other machines such as a personal computer 107. When a personal computer is used, registration is initiated by an end user opening a Web browser to the operator's Web site registration page (or set of registration pages). When a portable computing device is used, registration may be initiating through a mini-browser or other similar interface. These techniques are merely representative, as any convenient technique (including, without limitation, email, filling out and mailing forms, and the like) may be used. Thus, in the illustrated embodiment, users register with the Reminder Server 100 (or set of servers) either through Internet connections from personal computers, or via remote registration through a mobile device.

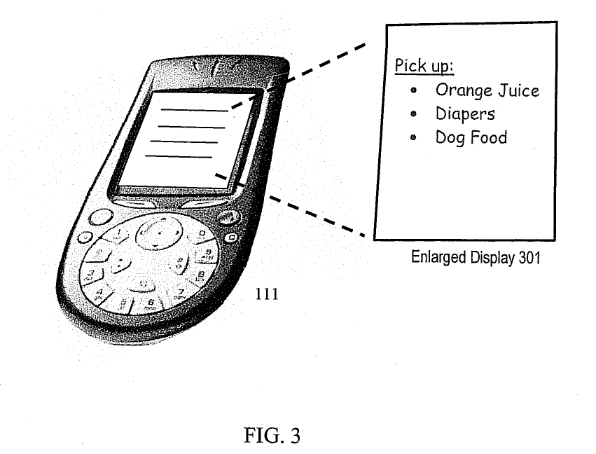

FIG. 3 illustrates a computing device 111 configured with appropriate hardware and software to display a to-do list according to at least one embodiment of the invention. As shown, the computing device 111 may take the form of a handheld device such as a cell phone or PDA and includes display functionality and user interface controls. Such a portable computing device 111 runs Reminder Software and is thereby operative to detect the presence of RFID tags within proximity of the user and receive any Tag Establishment Data stored within the RFID tags. The RFID tags may be basic passive tags or may be active tags that employ a powered transmitter. The portable computing device 111 includes a user interface including display features and user input features. In typical embodiments a graphical user interface is enabled upon the display that allows users to enter information and/or make selections to configure and/or direct the Reminder Software. In addition the display features of the portable computing device 111 are also used by the present invention to present aural and/or visual contents of Reminders. In the example of the figure, the display shows a textual Reminder created by a user that takes the form of a digital to-do list that has been relationally associated with a grocery store establishment that the user typically visits. As shown on the right side of FIG. 3, element 301 is an enlargement of a sample display of the Reminder (digital to do list) as it might appear upon the display of the portable computing device upon the user coming within proximity of the physical tag affixed to the entrance of the grocery store. Thus, for example, as the user walks up to the entrance of his or her typically visited grocery store, an alert triggers upon the portable computing device 111. In this example the alert is an aural and tactile alarm that gains that attention of the user. The user looks at the portable computing device 111 and finds digital to-do list 301 displayed. He or she is thereby reminded that Orange Juice, Diapers, and Dog Food need to be purchased at this store. In this way, the unique functionality of the present invention performs a valuable service for the user.

A single digital Reminder (like a digital to-do list) may be associated with a plurality of different establishments in the physical world. This is because the user may wish to be alerted to this Reminder when he or she comes within proximity of each of a number of different physical establishments relevant to the particular to-do list.

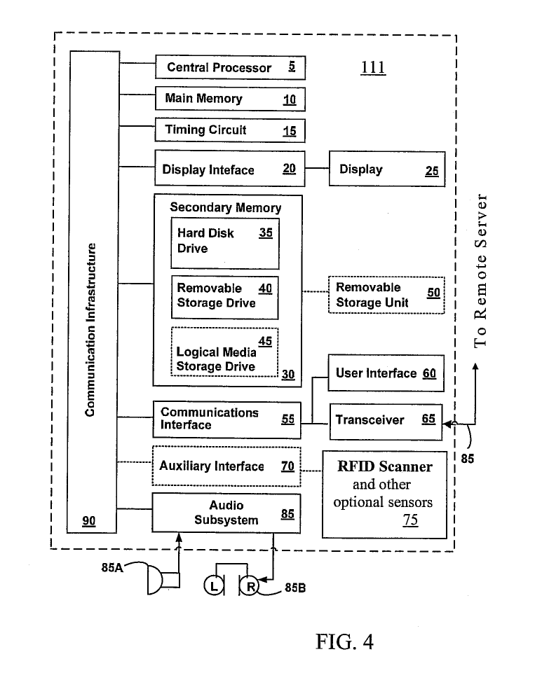

FIG. 4 illustrates a generalized block diagram of a portable computing device 111 according to at least one embodiment of the invention. The portable computing device 111 includes a communications infrastructure 90 used to transfer data, memory addresses where data items are to be found and control signals among the various components and subsystems of the computing device 111.

A central processor 5 is provided to interpret and execute logical instructions stored in the main memory 10. The main memory 10 is the primary general purpose storage area for instructions and data to be processed by the central processor 5. The main memory 10 is used in its broadest sense and includes RAM, EEPROM and ROM. A timing circuit 15 is provided to coordinate activities within the portable computing device. The central processor 5, main memory 10 and timing circuit 15 are directly coupled to the communications infrastructure 90.

A visual display interface 20 is provided to drive a visual display 25 associated with the portable computing device 111. The visual display interface 20 is electrically coupled to the communications infrastructure 90 and provides signals to the visual display 20 for visually outputting both graphics and alphanumeric characters. The display interface 20 may include a dedicated graphics processor and memory to support the displaying of graphics intensive media. The display 20 may be of any type (e.g., cathode ray tube, gas plasma) but in most circumstances will usually be a solid state device such as liquid crystal display. A secondary memory subsystem 30 is provided which houses retrievable storage units such as a hard disk drive 35, a removable storage drive 40, an optional a logical media storage drive 45 and an optional removal storage unit 50.

The removable storage drive 40 may be a replaceable hard drive, optical media storage drive or a solid state flash RAM device. The logical media storage drive 45 may be flash RAM device, EEPROM encoded with playable media, or optical storage media (CD, DVD). The removable storage unit 50 may be logical, optical or of an electromechanical (hard disk) design.

A communications interface 55 subsystem is provided which allows for standardized electrical connection of peripheral devices to the communications infrastructure 90 including, serial, parallel, USB, and Firewire connectivity. For example, a user interface 60 and a transceiver 65 are electrically coupled to the communications infrastructure 90 via the communications interface 55. For purposes of this disclosure, the term user interface 60 includes the hardware and operating software by which a user executes procedures on the portable computing device 111 and the means by which the computing device displays information to the user.

The user interface 60 employed on the portable computing device 111 may include a pointing device (not shown) such as a mouse, thumbwheel or track ball, an optional touch screen (not shown); one or more pushbuttons (not shown); one or more sliding or circular rheostat controls (not shown), one or more switches (not shown), and/or a tactile feedback unit (not shown); One skilled in the art will appreciate that the user interface devices which are not shown are well known and understood.

The portable computing device 111 also includes one or more sensors 75, including a scanner sensor for detecting RFID tags and reading data from the tags. The sensors may also include a GPS transducer and/or other spatial tracking sensors. In additional orientation sensors such as magnetometer sensors and/or accelerometer sensors may be used. The sensors may also be external peripherals connected to the portable computing device and maintained local to the user such that they track the user's position and/or orientation within the physical world. The sensors may interface directly with the communication interface or may connect through an optional auxiliary interface 70 to couple such sensors to the communications infrastructure 90.

The transceiver 65 facilitates the remote exchange of data and synchronizing signals between the portable computing device and other computing devices, including a remote server that may act as the Reminder Server. The transceiver 65 may be of a radio frequency type normally associated with computer networks for example, wireless computer networks based on BlueTooth (™) or the various IEEE standards 802.11.sub.x., where x denotes the various present and evolving wireless computing standards. Alternately, digital cellular communications formats compatible with for example GSM, 3 G and evolving cellular communications standards. Both peer-to-peer (PPP) and client-server models are envisioned for implementation according to embodiments of the invention. In a third alternative embodiment, the transceiver 65 may include hybrids of computer communications standards, cellular standards and evolving satellite radio standards.

Last, an audio subsystem 85 is provided and electrically coupled to the communications infrastructure 90. The audio subsystem provides for the playback and recording of digital media, for example, multi or multimedia encoded in any of the exemplary formats MP3, AVI, WAV, MPG, QT, WMA, AIFF, AU, RAM, RA, MOV, MIDI, etc. Such media files may include a user's own voice speaking the digital Reminder. The audio subsystem includes a microphone input port 85A and a headphone or speaker output port 85B. Connection of the microphone 85A and/or headset 85B includes both traditional cable and wireless arrangements known in the art. As referred to in this specification, “media” refers to video, audio, streaming and any combination thereof. In addition, the audio subsystem is envisioned to optionally include features such as graphic equalization, volume, balance, fading, base and treble controls, surround sound emulation, and noise reduction. One skilled in the art will appreciate that the above cited list of file formats is not intended to be all inclusive.

The portable computing device 111 includes an operating system, the necessary hardware and software drivers necessary to fully utilize the devices coupled to the communications infrastructure, and at least one Reminder Program operatively loaded into main memory 10. Optionally, the portable computing device 111 may include at least one remote authentication application, one or more cryptography applications capable of performing symmetric and asymmetric cryptographic functions, and secure messaging software. Not shown is the Reminder Server which may be a single computer or a plurality of computers. Portable computing device 111 may be coupled to the Reminder Server by a bidirectional communication link 85. Microprocessor 5 is also operative to read data from sensors 75 which includes at least one RFID scanner. Other sensors may include magnetometer orientation sensor and/or GPS sensors. Not shown in FIG. 4 is the power source which is likely rechargeable batteries. As mentioned previously, the portable computing device 111 has access to a Reminder Database which is preferably stored locally in the primary and/or secondary memory on board the portable computing device 111.

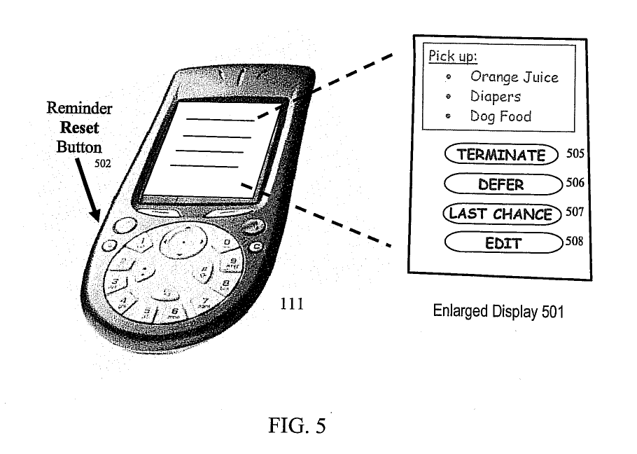

FIG. 5 illustrates user interface options provided to a user upon the triggering and display of a Personal Digital Reminder according to at least one embodiment of the invention. As shown, the user may Reset the Reminder by pressing physical button 502. The resetting function may be configured to causes the Reminder Software to remove it from the screen and reset the software flags such that the Reminder will not trigger again unless the user leaves the Trigger Establishment and then enters it again.

Referring back to FIG. 5, the present invention provides additional innovative user interface options to the user upon the display of a triggered Reminder. These user interface options may be enabled through a variety of different user interface elements and/or controls. In this example the user interface options are provided as graphical buttons displayed upon screen 501. As shown in the figure, these user interface options include Terminate 505, Defer 506, Last Chance 507, and Edit 508. Each of these options, upon selection by the user, cause the Reminder Software running upon the portable computing device 111 to take certain actions. These actions are described below:

Upon the selection of a Terminate (or equivalent) user interface option 505 by the user, the Reminder Software clears the screen of the displayed Reminder and removes the Reminder from the Reminder Database and/or sets the Reminder to an inactive state. In either case the Reminder is no longer active and will no longer trigger alerts and/or be displayed based upon the user's traversal of the physical world. Thus a user who is displayed a Reminder and acts on that Reminder and/or determines that the Reminder is no longer relevant or important can select the terminate user interface option.

Upon the selection of a Defer (or equivalent) user interface option 506 by the user, the Reminder Software clears the screen of the displayed Reminder and sets a software flag such that the Reminder will be displayed again after a certain amount of time has elapsed, that certain amount of time being referred to herein as the Defer Delay Time. Thus upon a user selecting the Defer user interface option 506, the Reminder Software of the present invention is operative to clear the screen and begin a process of determining if and when the Defer Delay Time has elapsed. This if often achieved by setting a counter to the number of seconds in the Defer Delay Time and decrementing the counter at repeated intervals that correspond with the elapsed number of seconds. When the counter is decremented to 0, the Reminder is displayed again to the user. In one example embodiment the user drives to Wal-Mart and upon coming within close proximity of the entrance to the store, is alerted to a Reminder. Upon viewing the Reminder, the user is displayed text that says “Buy Raisin Bran.” Thus upon entering the store the user is reminded to buy the needed cereal. The user then selects the Defer user interface option, causing the display to be cleared and causing the software to start counting down the Defer Delay Time. In some embodiments the Defer Delay Time may be a constant set in memory such as 600 seconds. In other embodiments the Defer Delay Time is retrieved from the Reminder Database wherein a different value is stored for each Reminder. The value may be stored in the Reminder[ID].Defer_Time variable for that Reminder ID. Thus the software of the present invention may retrieve this value from memory, update a counter to that value, and begin tracking elapsed time. When the elapsed time has passed, the Reminder is triggered again. In this example, this may happen 7 minutes after the defer option was selected. At this point the user may be well within the store, well into his or her shopping, and may still have forgotten to get Raisin Bran. Thus the user is reminded again after the Defer Delay Time and is thereby less likely to forget to the needed cereal. Upon viewing the Reminder on this second time, the user may elect to Terminate the Reminder by selecting that option from the user interface. This would be the likely selection if the user has already gotten the Raisin Bran. On the other hand, if the user still needs to get the Raisin Bran and is worried about still forgetting, the user may select the Defer option again. The defer process is then repeated.

Upon the selection of a Last Chance (or equivalent) user interface option 507 by the user, the Reminder Software of the present invention clears the screen of the displayed Reminder and sets a software flag such that the Reminder will be displayed again when the user leaves the Trigger Establishment that triggered the alert. Thus upon a user selecting the Last Chance user interface option, the Reminder Software of the present invention is operative to clear the screen and begin a process of determining if and when the user exits the Trigger Establishment that he or she is currently within. This may be determined based upon losing the signal detected from an RFID tag, the signal including the Tag Establishment Data that correlated with the Trigger Establishment. Thus when the data is lost (no longer detected), it is determined that the user has left the proximity. This may be useful for Trigger Establishments that indicate particular spatial portions of establishments, such as the dairy section of a grocery store. This is useful because it gives the user a last chance to remember to perform the task or tasks in the Reminder before significantly departing the trigger establishment. In one embodiment the user enters the dairy section of a grocery store, is reminded to buy milk, and then selects “last chance” option on the user interface. The Reminder disappears. The user then leaves the dairy section and the alert and Reminder is displayed again, making sure the user did not forget the milk before departing the dairy section.

In other embodiments, leaving a Trigger Establishment is determined by specifically detecting data from the RFID tag that indicates that the user is moving out of the establishment. This may be performed by reading a tag that is specifically associated with an exit from the establishment. This may be performed by reading data from two sequentially detected tags, the order that the tags were detected providing directional information about the motion of the user. If the using is moving into the establishment, the tags are detected in a first order (by virtue of coming within proximity of them in that order). If the user is moving out of the establishments the tags are detected in a second order (by virtue of coming within proximity of them in that order). Thus by detecting a plurality of distinguishable tags in a certain order, the software of the present invention can be configured to determine if a user is entering or exiting a particular Trigger Area. In this way the software of the present invention can trigger alerts and/or display Reminders based upon an entry or an exit or both an entry and an exit. And in this way a last chance Reminder can be imparted as described herein. The last chance Reminder in this example is triggered upon the user leaving the establishment.

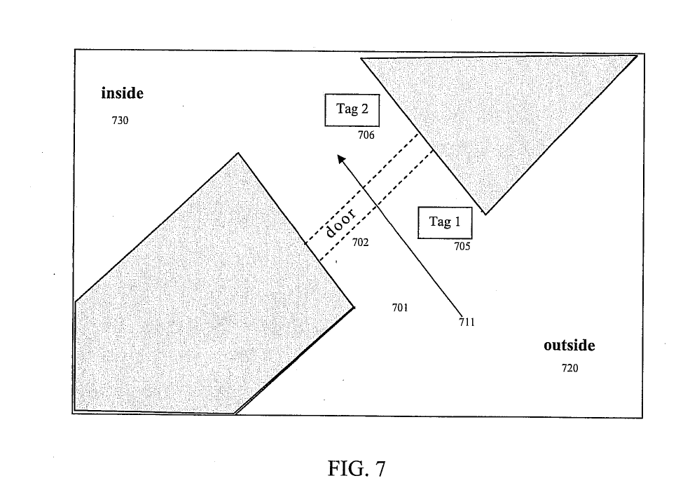

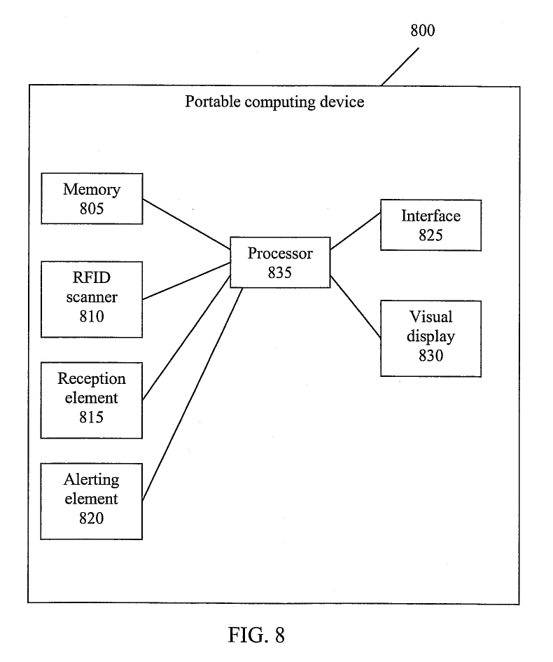

FIG. 7 illustrates the entry to an establishment shown as an overhead layout view according to at least one embodiment of the invention. FIG. 7 clarifies the process of detecting and entry or exit using the sequence of detected RFID tags. This establishment may be a grocery store, for example. The establishment includes an entry area 701 that a user must pass through, the entry area generally including a door 702 shown as a set of dotted lines. The user entering the establishment will thus be required to pass by two RFID tags, including Tag 1 705 and Tag 2 706. To enter the establishment the user will follow the direction of arrow 711, thereby passing from outside 720 of the establishment to inside 730 of the establishment. Thus by entering in the direction or arrow 711, the user will first pass within a scanning proximity of Tag 1 705 and then pass within a scanning proximity of Tag 2 706. By detecting this order of tags (first tag 1 then tag 2) the software of the present invention may determine that the user has entered the establishment. Conversely if a user exits the establishment (e.g., passes from inside 730 the establishment to outside 720 the establishment) he or she must move in the direction opposite to arrow 711. By doing so he or she must come within proximity first of Tag 2 and then within proximity of Tag 1. By detecting this order of tags (first tag 2 706 and then tag 1 705) the software of the present invention may determine that the user has exited the establishment. By enabling such detection, the software of the present invention may trigger alerts selectively upon either the entry, exit, or both entry and exit, of Trigger Establishment. And as described herein, a Last Chance may be specified which will give a user a final triggering of a Reminder as he or she exits an establishment to make sure he or she did not forget to act upon the contents of the Reminder.

The use of a plurality of tags, each distinguishable based upon data stored in memory, is a valuable feature of embodiments of the present invention. Some methods according to the present invention use the sequential order of detection of such distinguishable tags to determine an entry or exit direction of the user into or out of an establishment. Such methods rely upon tags being placed in a pre-determined relative locations within an establishment, ideally locations wherein user motion past are constrained and well known, for example, through typical entry area. In common embodiments of the present invention a standard data code is put within tags on the outside portion of an entry area and a different standard data code is stored within tags on the inside portion of an entry area. By detecting these two standard data codes and determining the order in which they were detected (within a particular amount of time) the software of the present invention may determine if a user has entered or exited a particular Trigger Establishment.

In one example embodiment, a user goes to a local Safeway Grocery Store and upon entering the store of the store, is alerted to a Reminder using the methods described herein. Upon viewing the Reminder, the user is played an audio voice Reminder that says “Pick up your Prescription.” This message is also written in text upon the screen. Thus upon entering the store the user is reminded to stop at the pharmacy and pick up his prescription medication. The user then selects the Last Chance user interface option, causing the display to be cleared and causing the software to configure itself such that the user will be reminded again upon exiting the Trigger Establishment. In this way, the user will be alerted again to the Reminder upon leaving the store in case he forgot to pick up his prescription. Hence the substantial benefit enabled by the unique methods disclosed herein for distinguishing between entry and exit of a Trigger Establishment.

Upon the selection of the Edit (or equivalent) user interface option 508 by the user, the Reminder Software of the present invention enables the user to edit the content of the Personal Digital Reminder. The user may, for example, add material, remove material, and/or change material. In this way the user can update the Reminder based upon whether or not a portion of the reminded task has been performed. In one example embodiment the user goes to a local Seven-Eleven and upon entering the establishment, is alerted to a Reminder. Upon viewing the Reminder, the user is presented with a shopping list that includes numerous items that the user needs to purchase. The user may purchase some of those items, although not all of the items may be for sale at the store. The user may thus wish to update the Reminder to-do list by selecting the edit option. By using the edit option, the user may cross items off the digital shopping list.

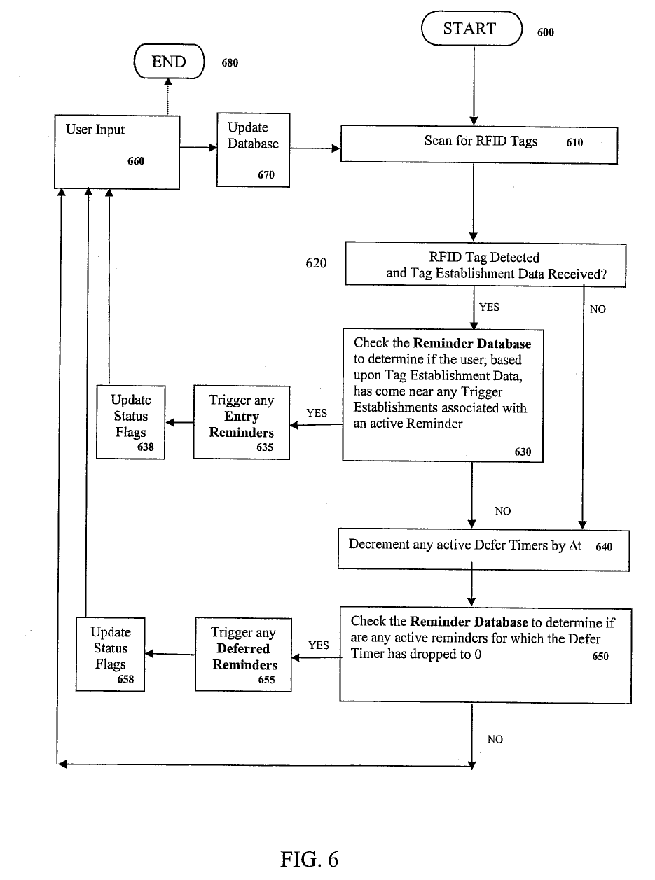

FIG. 6 illustrates is an example software flow diagram according to at least one embodiment of the present invention. The process starts at step 600 wherein a Reminder Trigger Routine is initiated or called. The software flow proceeds to step 610 wherein the Reminder Software running upon the processor of the portable computing device 111 reads data from the RFID scanner to determine whether there is a tag within range. The process then proceeds to step 620 wherein any received data is processed to determine if an RFID Tag was detected and if the received data includes any Tag Establishment Data. If no Tag Establishment Data was determined to be received, the process jumps ahead to 640 as shown in the figure. If Tag Establishment Data was determined to be received, the process proceeds to step 630 to check if the Tag Establishment Data corresponds with the Trigger Establishments of any active Personal Digital Reminders.

At step 630 the Reminder Software running upon the portable computing device accesses the Reminder Database and determines if the user, based upon the Tag Establishment Data, is currently within close proximity of any Trigger Establishments associated with any currently active Personal Reminders. This is performed by checking if the received Tag Establishment Data correlates to any Trigger Establishments relationally associated with currently active Reminders in the Reminder Database. If one or more Trigger Establishments are found to correlate, the flags in the Reminder Database are checked to see if these establishments triggered in a previous cycle. In other words, the flags are checked to determine whether the user just came within proximity of the RFID tag for the first time, or if a correlation was determined previously and the Reminder already triggered. This is done by simply determining if the Tag Establishment Data correlates with a Trigger Establishment that is not currently identified by an Entry_Status_Flag to be an establishment that the user is currently in. If this is true, he or she must have just entered the Trigger Establishment since the last time the data was updated.

In this way it can be determined if a user entry to the Trigger Establishment has occurred. If it is determined that the user has entered one or more Trigger Establishments, the process proceeds to step 635. At step 635 any Reminders that are configured to trigger upon the user entering are triggered. The user is alerted to these Reminders and the Reminders are displayed to the user. The process then proceeds to step 638 wherein any status flags that need updating are updated. For example, the Entry_Status_Flag for any Reminders that the user just entered are changed in value from 0 to 1, thereby indicating that the user is now inside a Trigger Establishment associated with those Reminders.

The process then proceeds to step 660 wherein the user is given the opportunity to provide input through the user interface of the present invention. It is at this step that the user interface options are presented to the user and the user may, for example elect to terminate the currently displayed Reminder, edit the currently displayed Reminder, defer the currently displayed Reminder, last chance the currently displayed Reminder, or reset the currently displayed Reminder. Depending upon what actions were selected by the user, the process proceeds to 670 wherein the Reminder Database is updated to reflect any terminations, edits, last chances, resettings, or deferments, of Reminders. The process then loops back to step 610 wherein the RFID tags are scanned for once again.

Referring to step 630 in the previous cycle, if it had been determined that the user had not entered one or more Trigger Establishments, the process would have proceeded to step 640 instead of 635 as described above. At step 640 the Reminder Software running upon the portable computing device 111 decrements any active Defer Timers that may have been previously set. The timers are decremented by a time delta t equal to the amount of time that has elapsed since the last time the timers were decremented. In this way the timers keep track of elapsed time. In some embodiments the timers are maintained in a background process that occurs in parallel with the current steps. The software can determine which Reminders have Defer Timers associated with them by checking the Defer_Status_Flag, a binary value that indicates a Reminder has a deferred presentation pending if set to 1.

The process then proceeds to step 650 wherein the software accesses the Reminder Database and determines if any Defer Timers have been decremented to 0 thereby indicating that the elapsed time of the deferment for that Reminder has expired. If so, the process proceeds to step 655. At step 655 any Reminders that are configured to trigger upon the expiration of a deferment time interval are triggered. The user is alerted to these Reminders and the Reminders are displayed to the user. The process then proceeds to step 658 wherein any status flags that need updating are updated. For example, the Defer_Status_Flag for any Reminders that the user was just presented with is changed in value from 1 to 0, thereby indicating that a deferred presentation is no longer pending for that Reminder.

If it had been determined at step 650 that no Defer Timers had expired since the data was last checked, the process would have proceeded to step 660 instead of 655. At step 660 the user is given the opportunity to provide input through the user interface of the present invention. It is at this step that the user interface options are presented to the user and the user may, for example elect to terminate any currently displayed Reminders, edit any selected Reminders, defer any currently displayed Reminders, last chance any currently displayed Reminders, or reset any currently displayed Reminders. Depending upon what actions were selected by the user, the process proceeds to 670 wherein the Reminder Database is updated to reflect any terminations, edits, last chances, resettings, or deferments, of Reminders. The process then loops back to step 610 wherein the GPS location is checked once again. Note, at step 660 the user may also be given the option of exiting the software routine and thereby ending the automated Reminder process. If the user elects this option, the routine ends at step 680.

It should be noted that the aforementioned software flow is merely provided for illustrative purposes to demonstrate the general process involved and can be configured in many alternate ways. Certain features and options are not shown.

FIG. 8 illustrates a portable computing device 800 according to at least one embodiment of the invention. The portable computing device 800 includes a memory 805 to store at least one personal reminder. Each of the at least one personal reminder comprises reminder content and at least one trigger establishment relationally associated with the reminder content. The reminder content identifies at least one task that the user selects to complete in the future. Trigger establishments indicate at least one of: names and/or other unique identifiers (IDs) of establishments, types of establishments, and portions of the establishments in a real physical world. An RFID scanner 810 detects an RFID chip within a certain local proximity of the portable computing device 800. The RFID scanner 810 may be a component that is integrated into the primary casing of the portable computing device or may be a peripheral component that is connected externally.

The detected RFID chip stores at least one of establishment data indicative of a name or ID of an establishment, a type of establishment, and a portion of the establishment to which the RFID is proximally located. A reception element 815 receives a representation of the establishment data from the RFID chip to the portable computing device 800 using a radio communication link between the RFID chip and the RFID scanner 810. An alerting element 820 alerts the user of the portable computing device 800 of the reminder content of at least one personal reminder based at least in part upon a trigger establishment of the at least one personal reminder matching at least one of: the name or unique ID of the establishment, the type of the establishment, and the portion of the establishment indicated by the establishment data.

An interface 825 is utilized to receive an authored personal reminder from the user. The personal reminder is stored in the memory 805. The portable computing device 800 also includes a visual display 830 to display a textual representation of the reminder content from the alerting element 820. A processor is in communication with each of the memory 805, the RFID scanner 810, the reception element 815, the alerting element 820, the interface 825, and the visual display 830.

As described previously a user may author a Personal Digital Reminder directly upon the portable computing device or may author the Reminder on an alternate computer and download it into the portable computing device. The authoring process may include entering text, recording voice audio, and/or recording video as a means of generating and/or capturing Reminder content. The authoring process also includes defining one or more associated Trigger Establishments. There are a number of ways in which a user may define and associate Trigger Establishments with a Reminder. In some embodiments the user selects a Trigger Establishment from a menu of possible Trigger Establishments. The user, for example, may create a grocery list and then associate the grocery list with the appropriate Trigger Establishments by selecting the related establishments from the menu. In preferred embodiment the user is provided with a menu of choices for establishments and/or types of establishments and/or spatial portions of establishments to relationally associate a Reminder.

In some embodiments the portable computing device of the present invention accesses a remote server that has a database of Trigger Establishment information including a plurality of particular establishments, types of establishments, and/or spatial portions of establishments. The stored data is such that the Trigger Establishments are correlated to corresponding Tag Establishment Data at those locations. For example, if the user creates a Reminder to get gasoline, the user may link that Reminder to all BP Gas Stations by selecting that type of establishment. The portable computing device may access the correct Trigger Establishment information by accessing the Reminder Server and downloads one or more Trigger Establishments associated with BP Gas Stations, the Trigger Establishment data being relationally correlated with the Tag Establishment Data that is accessible by radio link at each of the BP Gas Stations. In this way the Reminder Server may maintain a database of Trigger Establishment Information that is correlated with the corresponding Tag Establishment Data encoded in RFID tags at each respective location, the portable computing devices of the present invention accessing the Reminder Server as needed. In some embodiments users must subscribe to a service to be provided access to the Reminder Server. In this way the features of the present invention may be provided in exchange for a service fee. In other embodiments such a service fee is not required.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided.

This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. An RFID enabled personal reminder method, comprising:
storing at least one personal reminder upon a portable computing device, each of the at least stored personal reminder comprising reminder content and at least one trigger establishment relationally associated with the reminder content, the reminder content identifying at least one task to be completed by the user in the future, the at least one trigger establishment indicating at least one of: a unique establishment, a unique type of establishment, and a unique portion of an establishment in a real physical world;
detecting an RFID chip within a local proximity of the portable computing device by using an RFID scanner that is proximal to and in communication with a processor of the portable computing device, wherein the detected RFID chip contains establishment data indicative of at least one of: the unique establishment, the unique type of establishment, and the unique portion of the establishment to which the RFID chip is proximally located;
receiving a presentation of the establishment data from the RFID chip on the portable computing device by using a radio communication link between the RFID chip and the RFID scanner; and
alerting the user of the portable computing device of the reminder content of at least one personal reminder based at least in part upon at least one trigger establishment of the at least one personal reminder matching at least one of: the unique establishment, the unique type of establishment, and the unique portion of the establishment indicated by the establishment data received from the RFID chip.

2. The RFID enabled personal reminder method of claim 1 wherein the alerting is further based at least in part upon a stored history of RFID chip detections.

3. The RFID enabled personal reminder method of claim 1 wherein the RFID chip is located proximal to at least one of an entrance and an exit of the establishment indicated by the establishment data stored within the RFID chip.

4. The RFID enabled personal reminder method of claim 1 wherein the RFID chip is located proximal to a particular portion of an establishment indicated by the establishment data stored within the RFID chip.

5. The RFID enabled personal reminder method of claim 1 wherein the RFID chip is a powered RFID chip.

6. The RFID enabled personal reminder method of claim 1 further comprising:
authoring the at least one personal reminder based upon the user's engagement with a user interface of the portable computing device; and
storing the at least one authored personal reminder in a memory of the portable computing device.

7. The RFID enabled personal reminder method of claim 6 wherein the authoring comprises at least one of selecting and defining at least one of: the name of the establishment, an identification (ID) of the establishment, the type of establishment, and the portion of the establishment to be relationally associated with the personal reminder content of the personal reminder.

8. The RFID enabled personal reminder method of claim 1 wherein the alerting comprises outputting a textual representation of the reminder content upon a visual display of the portable computing device.

9. The RFID enabled personal reminder method of claim 8 further comprising clearing the displayed reminder content from the display of the portable computing device based upon the user's engagement with a user interface of the portable computing device.

10. The RFID enabled personal reminder method of claim 1, further comprising resetting the at least one personal reminder after an alert has been displayed based upon the user's engagement with the user interface to enable the user to be alerted again to the at least one personal reminder only after the user exits the local proximity to the RFID chip and then subsequently reenters within the local proximity of the RFID chip.

11. The RFID enabled personal reminder method of claim 1, further comprising instructing the portable computing device to alert the user again to the reminder content after a defer delay time has elapsed based upon the user's engagement with a user interface of the portable computing device.

12. The RFID enabled personal reminder method of claim 1 wherein the reminder content comprises information represented as at least one of text, audio, images, graphics, and video.

13. The RFID enabled personal reminder method of claim 1 wherein a plurality of RFID chips are located near an entrance of a particular establishment and arranged such that an order of detection of the plurality of RFID chips by the RFID scanner of the portable computing device indicates whether the user is entering or exiting the establishment.

14. The RFID enabled personal reminder method of claim 13 wherein the alerting is performed based at least in part upon an determination as to whether the user is entering and/or exiting the establishment.

15. The RFID enabled personal reminder method of claim 1 wherein the alerting including outputting an audio and/or tactile stimulus to attract the user's attention.

16. A portable computing device with reminder capabilities, comprising:
a memory to store at least one personal reminder, each stored at least one personal reminder comprising reminder content and at least one trigger establishment relationally associated with the reminder content, the reminder content identifying at least one task to be completed by a user in the future, the at least one trigger establishment indicating at least one of: a unique establishment, a unique type of establishment, and a unique portion of the establishment in a real physical world;
an RFID scanner to detect an RFID chip within a local proximity of the portable computing device and to receive from the detected RFID chip, establishment data indicative of at least one of: the unique establishment, the unique type of establishment, and the unique portion of the establishment to which the RFID chip is proximally located;
an alerting element to alert the user of the portable computing device of reminder content of at least one personal reminder based at least in part upon at least one trigger establishment of the at least one personal reminder matching at least one of: the unique establishment, the unique type of establishment, and the unique portion of the establishment indicated by the establishment data received from the RFID chip;
a processor to selectively cause the alerting element to alert the user to a personal reminder based at least in part upon the establishment data received from the RFID chip matching at least one trigger establishment of the personal reminder.

17. The portable computing device of claim 16, further comprising an interface to receive an authored personal reminder from the user, wherein the authored personal reminder is stored in the memory.

18. The portable computing device of claim 17, wherein the authored personal reminder comprises at least one of a selecting and definition of at least one of: the name of the establishment, an identification (ID) of the establishment, the type of establishment, and the portion of the establishment to be relationally associated with the personal reminder content of the personal reminder.

19. The portable computing device of claim 16, further comprising a visual display to display a textual representation of the reminder content from the alerting element.

20. The portable computing device of claim 16, wherein the processor is adapted to reset the at least one personal reminder after an alert has been displayed based upon the user's engagement with the user interface to enable the user to be alerted again to the at least one personal reminder only after the user exits the local proximity to the RFID chip and then subsequently reenters within the local proximity of the RFID chip.

21. An RFID enabled personal reminder system comprising:
an RFID chip located proximal to a physical establishment in a real physical world, the RFID chip storing and transmitting establishment data indicative of at least one of: a unique establishment, a unique type of establishment, and a unique portion of the establishment to which the RFID chip is proximally located;
a portable computing device, comprising:
a memory to store at least one personal reminder, each stored at least one personal reminder comprising reminder content and at least one trigger establishment relationally associated with the reminder content, the reminder content identifying at least one task to be completed by a user in the future, the at least one trigger establishment indicating at least one of: a unique establishment, a unique type of establishment, and a unique portion of an establishment in the real physical world;
an RFID scanner to detect the RFID chip when the portable computing device comes within a local proximity of the RFID chip and to receive, from the RFID chip, the establishment data indicative of at least one of: the unique establishment, the unique type of establishment, and the unique portion of the establishment to which the RFID chip is proximally located;
an alerting element to alert the user; and
a processor in communication with the memory, the RFID scanner, and the alerting element, the processor being operative to selectively control the alerting element to alert the user of the portable computing device of reminder content of at the least one personal reminder based at least in part upon a trigger establishment of the at least one personal reminder matching at least one of: the unique establishment, the unique type of establishment, and the unique portion of the establishment indicated by the establishment data received from the RFID chip.

22. The RFID enabled personal reminder system of claim 20, further comprising an interface to receive an authored personal reminder from the user, wherein the authored personal reminder is stored in the memory.

23. The RFID enabled personal reminder system of claim 20, wherein the authored personal reminder comprises at least one of a selecting and definition of at least one of: the name of the establishment, an identification (ID) of the establishment, the type of establishment, and the portion of the establishment to be relationally associated with the personal reminder content of the personal reminder.

24. The RFID enabled personal reminder system of claim 20, further comprising a visual display to display a textual representation of the reminder content from the alerting element.

25. The RFID enabled personal reminder system of claim 20, wherein the processor is adapted to reset the at least one personal reminder after an alert has been displayed based upon the user's engagement with the user interface to enable the user to be alerted again to the at least one personal reminder only after the user exits the predetermined proximity to the RFID chip and then subsequently reenters within the predetermined proximity of the RFID chip.
